(19) United States
(12) Patent Application Publication
(10) Pub. No.: US 2001/0015936 A1
(43) Pub. Date: Aug. 23, 2001

(54) Static mixer

(75) Inventors: Rolf Heusser, Winterthur (CH); Markus Fleischli, Winterthur (CH)

Correspondence Address: J. Georg Seka, Townsend and Townsend and Crew LLP, Two Embarcadero Center, 8th Fl., San Francisco, CA, 94111, US

(73) Assignee: Sulzer Chemtech AG

(21) Appl. No.: 09/771,490

(22) Filed: Jan. 25, 2001

(30) Foreign Application Priority Data
Feb. 17, 2000 (EP) 00810133.9

(51) Int. Cl. B01F 5/06

(52) U.S. Cl. 366/337

(57) ABSTRACT

The static mixer (1) comprises a plurality of mixing chambers (8) which form a mixer structure (1′). The mixing chambers (8) are arranged one behind the other as well as adjacently in a tube (10) along a tube axis (11). They can be used for mixing at least two flowable components (A, B). The mixer structure represents a modification (9) of a basic structure (1″). In said basic structure (1″) the mixing chambers (8) are bounded off from one another by radial walls (2, 3) which are oriented in the direction of the tube axis and by walls (4, 4a, 4b) which are transverse to the tube axis. Apertures between adjacent chambers in the radial walls form inputs and outputs (6a, 6b and, respectively, 7a, 7b) for the components to be mixed. The modification (9) consists of structure changes at individual locations of the basic structure (1″). It is carried out in such a manner that a transversal dislocation of mix-resistant flow filaments (30) results in the flow of the components to be mixed, with these flow filaments being mix-resistant with respect to the basic structure.

The invention relates to a static mixer, to an apparatus comprising a mixer of this kind and to a use of the mixer.

Static mixers for mixing at least two flowable components which are compact and which in spite of a simple, material saving construction of their mixer structure yield good mixing results are described in EP-A-0 749 776 and EP-A-0 815 929. These mixers are suitable for mixing highly viscous substances such as for example sealing masses, two component foams or two component adhesive bonders. They can be economically manufactured of thermoplastics through injection molding so that they can be economically applied for a throw-away use. A “throw-away mixer” of this kind is mainly used for products which harden, since for these products the mixer can practically not be cleaned.

The mixing results of the named mixers are insufficient in individual applications, in particular in cases in which components are mixed which have different viscosity values. An insufficient mixing result becomes evident in that at least one flow filament which consists of only one of the components to be mixed passes through the mixer structure and in so doing experiences practically no or too slow a mixing with adjacent flow filaments. A flow filament of this kind is designated here as “mix-resistant”. Mix-resistant flow filaments arise above all in static mixers of which the mixer structure consists of a periodic succession of similar elementary mixing chambers. But mix-resistant flow filaments can also be observed in non periodical mixer structures.

The object of the invention is to create a static mixer of which the mixing result is improved in comparison with the known mixers. This object is satisfied by the static mixer which is defined in claim 1.

The static mixer comprises a plurality of mixing chambers which form a mixer structure. The mixing chambers are arranged one behind the other as well as adjacently in a tube along a tube axis. They can be used for mixing at least two flowable components. The mixer structure represents a modification of a basic structure. In said basic structure the mixing chambers are bounded off from one another by radial walls which are oriented in the direction of the tube axis and by walls which are transverse to the tube axis. Apertures between adjacent chambers in the radial walls form inputs and outputs for the components to be mixed. The modification consists of structure changes at individual locations of the basic structure. It is carried out in such a manner that a transversal dislocation of mix-resistant flow filaments results in the flow of the components to be mixed, with these flow filaments being mix-resistant with respect to the basic structure.

Through the transversal dislocation of the mix-resistant flow filament the latter enters into a region in which it is subject to a strong deformation and thereby becomes well miscible. The dislocated flow filament is replaced by another one which is now in turn largely decoupled from the mixing process. It is therefore advantageous if such disturbance locations, which cause a dislocation of the respective mix-resistant flow filament, are set up at a plurality of positions of the static mixer. It is also advantageous if the disturbance locations are formed differently.

The disturbance locations as a rule have a disadvantageous effect on the mixing process in flow regions which lie outside the mix-resistant flow filament. If this is the case, then only as many disturbance locations should be provided as are necessary for a sufficient number of dislocations of the mix-resistant flow filaments.

The disturbance locations can be formed such that they do not act directly on the mix-resistant flow filament, but rather indirectly in that they cause deflections in their direct region of influence which then in turn influence the mix-resistant flow filament. A design of suitable disturbance locations can be found empirically. Experiments with components which are to be mixed and which are differently colored are carried out and the results for a basic structure are compared with those of a modification of the basic structure, with it being possible to determine whether mix-resistant flow filaments have actually been dislocated.

Subordinate claims 2 to 6 relate to advantageous embodiments of the static mixer in accordance with the invention. Apparatuses with mixers of this kind and a use are the subject of claims 7 and 8 and, respectively, of claim 9.

In the following the invention will be explained with reference to the drawings. Shown are:

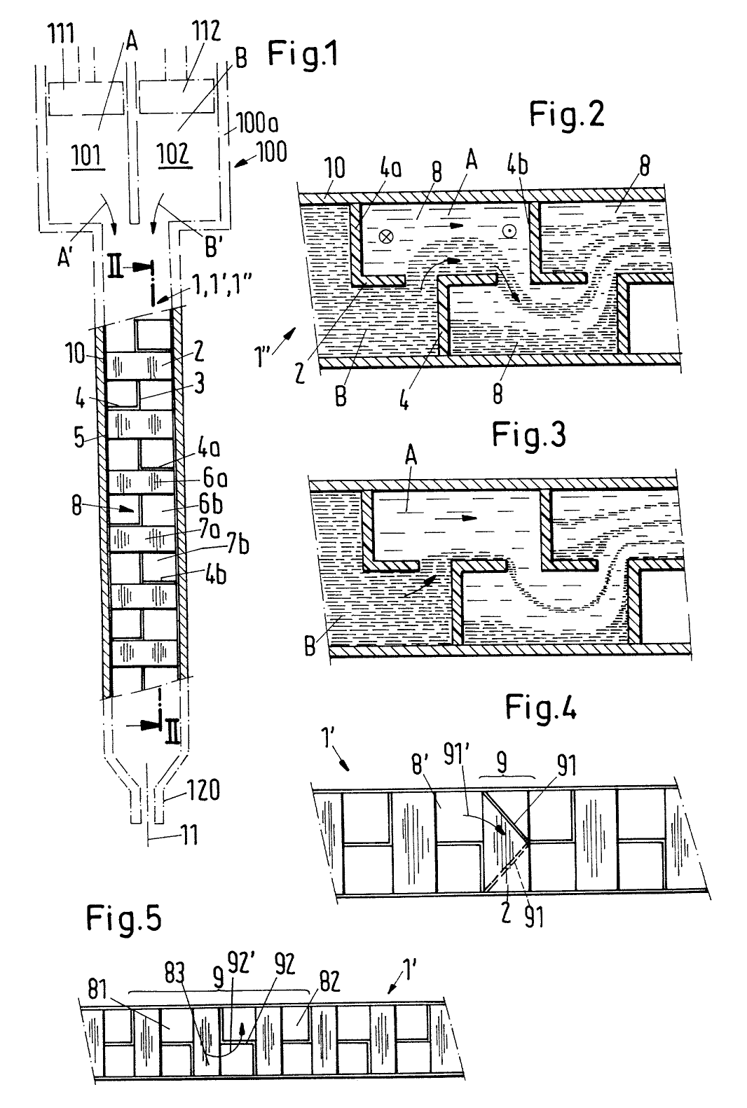

FIG. 1 a static mixer with a regular, non modified mixer structure which represents a basic structure,

FIG. 2 an illustration of the mixing process, drawn in accordance with results of a numerical simulation,

FIG. 3 an illustration corresponding to that in FIG. 2 for a mixing of two components, the viscosity values of which are substantially different,

FIG. 4 a first modification of the basic structure which is illustrated in FIG. 1,

FIG. 5 a second modification,

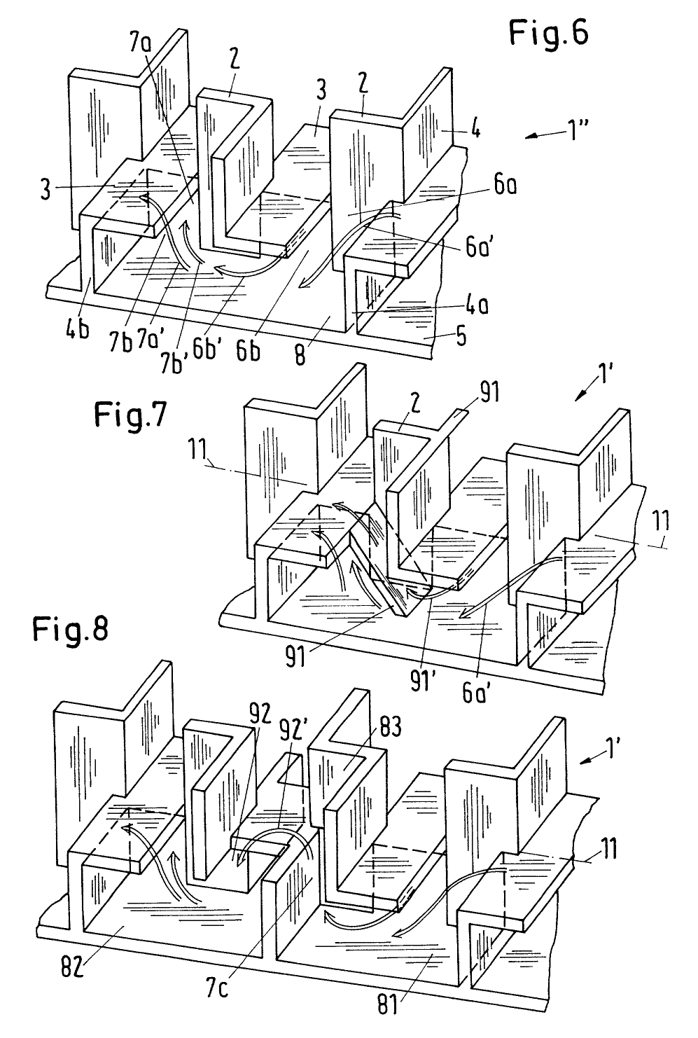

FIG. 6 an oblique view pertaining to the basic structure of FIG. 1,

FIG. 7 the basic structure with the first modification in accordance with FIG. 4,

FIG. 8 the basic structure with the second modification in accordance with FIG. 5,

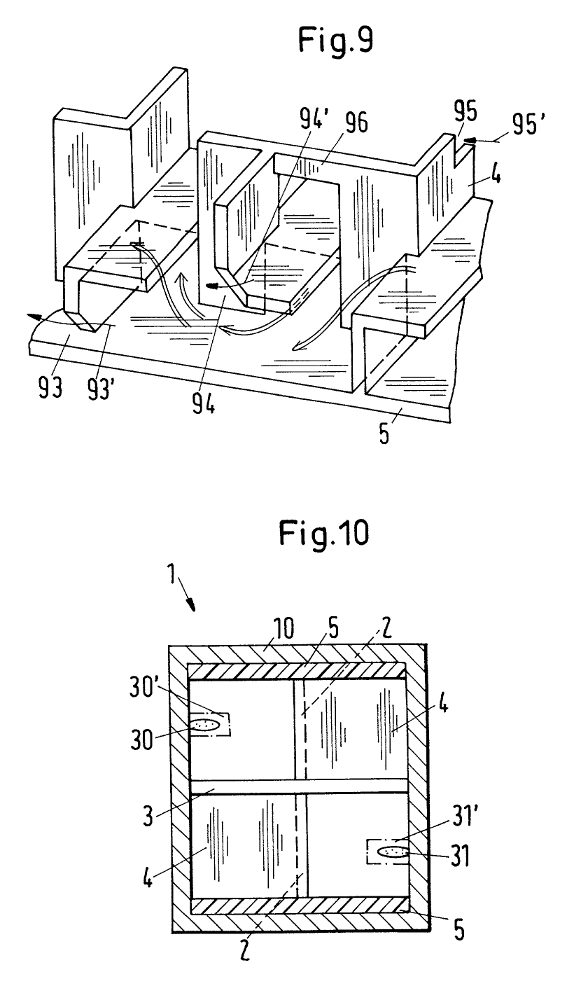

FIG. 9 further examples of modifications, and

FIG. 10 an illustration for the arising of mix-resistant flow filaments.

In FIG. 1 an apparatus 100 is indicated in chain dotted lines. The latter contains a static mixer 1, the mixer structure 1′ of which forms a regular, non modified basic structure 1″. The mixer structure 1′ is illustrated as a side view. It is known from the named EP-A-0 749 776 and EP-A-0 815 929 in which the basic structure 1″ is described in two different ways: The basic structure 1″ is composed of a plurality of mixing elements which are arranged one behind the other in a tube 10; or it consists of a bundle of four chambered strings, the mixing chambers 8 (“mix-active chambers”) of which in each case extend between two closed ends 4a and 4b. Each of the mixing elements comprises two axial sections, with at least one partitioning web 2 and 3 respectively (radial walls) which subdivides the section being associated with each of the sections. The partitioning webs 2, 3 cross one another and subdivide the tube cross-section into equally large sub-areas. The sub-areas are open or covered over by deflection discs 4. One recognizes further details in the drawings, in particular in FIG. 6, which illustrates a non modified basic structure 1″ with a completely shown mixing chamber 8.

The mixing chambers 8 of the basic structure 1″ are without installations, are equally large and are arranged with displacement with respect to one another. Two inputs 6a, 6b and two outputs 7a, 7b arranged in an alternating sequence form connections to four adjacent chambers. Two lateral reinforcement walls 5 extend over the entire length of the mixer 1.

The apparatus 100 comprises a two-chambered container 100a, namely a cartridge, with chambers 101 and 102. The latter serve for the separate reception of two flowable components A and B. A and B can be pressed in into the tube 10 (arrows A′, B′) through outputs of the container 100a by means of pistons 111 and 112. After a mixing of A with B in the static mixer 1, which is composed of the tube 10 and the mixer structure 1′, the mixture emerges from the apparatus 100 through a nozzle 120. The cartridge 100a can comprise more than two chambers. The tube 10 can be formed as a tube part which can be placed on onto the cartridge 100a.

A section in accordance with the line II-II is illustrated in FIG. 2. The two components A and B, which have the same values for the viscosity, flow through the mixer structure 1′. Arrows in the mixing chamber 8 indicate the path of the flow (with the symbols ‘circle with cross’ and ‘circle with dot’ meaning downward and upward arrows respectively with respect to the plane of the drawing). The flow pattern is drawn in accordance with results of a numerical simulation. As one sees, the flow filaments appear as layers of similar thickness; this means a good mixing.

FIG. 3 shows an illustration corresponding to that of FIG. 2, here for two components A and B, the viscosity values of which differ by a factor of 100. The less viscous component B forms much narrower layers, since this component flows faster. The flow filaments propagate irregularly. A further irregularity is particularly strongly developed over a cross-section which is perpendicular to the illustrated section. These irregularities have a poor mixing as a result.

As a result of the drawbacks that the mixing process displays, mix-resistant flow filaments result, against the unfavorable influence of which, which is visible in the mixed product, the measures in accordance with the invention are directed. These measures, in the form of a modification of the basic structure, have been successful; two successful cases with in each case one modification 9 are illustrated in FIGS. 4 and 7 and, respectively, FIGS. 5 and 8. The mixer structures which are illustrated in FIGS. 6 to 8 are illustrated with only one reinforcement wall 5 for the better recognizability of the essential features.

The modification 9 in accordance with FIGS. 4 and 7 is formed by an inclined web 91 in the mixing chamber 8′ which is inclined with respect to the tube axis 11 or axis of the mixer structure 1′. The web 91 connects on a radial wall 2 an input 6b to an output 7a in such a manner that the flow is deflected by the web 91 from the tube wall 10 in the direction towards tube axis 11 (arrow 91′). The reverse is also possible: a flow deflection by the web 91 from the tube axis 11 in the direction towards the tube wall 10.

The modification 9 in accordance with FIGS. 5 and 8 is formed by shortenings of the lengths of three adjacent chambers 81, 82 and 83 with a simultaneous lowering of the number of inputs or outputs. In this the pair of chambers 81 and 82, which lie one behind the other along the tube axis 11, is arranged laterally to the third chamber 83. Two apertures 7c and 92 produce a connection (arrow 92′) between the two chambers of the pair 81, 82.

A modification 9 advantageously comprises a plurality of disturbance locations with modification elements 91 (first modification) or 81, 82, 83, 92 (second modification) respectively, which are preferably positioned regularly over the entire length of the static mixer 1. A non-illustrated combination of the two modification elements 91 and 81, 82, 83, 92 respectively is particularly advantageous.

Further possibilities of modifying the basic structure are illustrated in summary in FIG. 9: a) broken out wall pieces 93, 94 and 95 which cause bypass flows (arrows 93′, 94′ and 95′); and b) added webs 96 which narrow the passages between mixing chambers 8.

Finally, FIG. 10 schematically shows mix-resistant flow filaments 30 and 31 with reference to a cross-section through the static mixer 1. The contours of these flow filaments are less clear than illustrated; they are toothed diffusely and are located in a further surrounding 30′ and 31′ respectively.

The mixer structures 11′ of the described embodiments are advantageously formed in each case monolithically; they can in particular be injection molded of a thermoplastic. The mixer structure 11′ has a rectangular cross-section and comprises four adjacently arranged chamber strings. Each string forms a series of from 5 to 15 mixing chambers 8. Each chamber 8 of the basic structure has a length which is 1.5 to 2.5 times as long as a chamber width, with this width being greater than 1 mm and less than 10 mm, preferably at least 2 mm and a maximum of 5 mm.

The apparatus 100 is suitable for mixing a highly viscous component A with at least one further component B which can have a viscosity which is lower by a factor of 10 to 1000. The mass flow of the further component can be smaller than the mass flow of the highly viscous component by a multiple, for example by a factor of 10.

1. Static mixer (1) comprising a plurality of mixing chambers (8) which form a mixer structure (1′), which are arranged one behind the other as well as adjacently in a tube (10) along a tube axis (11) and which can be used for mixing at least two flowable components (A, B), with the mixer structure representing a modification (9) of a basic structure (1″),
in said basic structure (1″) the mixing chambers (8) being bounded off from one another by radial walls (2, 3) which are oriented in the direction of the tube axis and by walls (4, 4a, 4b) which are transverse to the tube axis and apertures between adjacent chambers in the radial walls forming inputs and outputs (6a, 6b and, respectively, 7a, 7b) for the components to be mixed,
whereas the modification (9) consists of structure changes at individual locations of the basic structure (1″) and is carried out in such a manner that a transversal dislocation of mix-resistant flow filaments (30) which are mix-resistant with respect to the basic structure results in the flow of the components to be mixed.

2. Static mixer in accordance with claim 1, characterized in that the mixing chambers (8) of the basic structure (1″) are equally large chambers without installations and are arranged to be displaced with respect to one another in such a manner that two inputs (6a, 6b) and two outputs (7a, 7b) form connections to four adjacent chambers.

3. Static mixer in accordance with claim 1 or claim 2, characterized in that the modification (9) is formed at least partly by webs (91) which are at an inclination to the tube axis (11) and which in each case in a mixing chamber (8′) on a radial wall (2, 3) connect (91′) an input (6b) to an output (7a) in such a manner that the flow is deflected by the web from the tube wall (10) in the direction towards the tube axis (11) or, vice versa, from the tube axis in the direction towards the tube wall.

4. Static mixer in accordance with any one of the claims 1 to 3, characterized in that the modification (9) is formed at least partly through shortenings of the lengths of three adjacent chambers (81, 82, 83) while simultaneously reducing the number of inputs or outputs, with a pair of chambers (81, 82) which are arranged one behind the other along the tube axis (11) forming two of these chambers and with the third chamber (83), which is arranged laterally to the chamber pair, producing a connection (92′) between the two chambers of the pair via two apertures (7c, 92).

5. Static mixer in accordance with any one of the claims 1 to 4, characterized in that the mixer structure (1′) is formed monolithically, in particular is injection molded of a thermoplastic.

6. Static mixer in accordance with any one of the claims 1 to 5, characterized in that the mixer structure (1′) has a square or rectangular cross-section and comprises four adjacently arranged chamber strings, each string forms a series of from 5 to 15 chambers (8) and each chamber of the basic structure (1″) has a length which is 1.5 to 2.5 times as long as a chamber width, with this width being greater than 1 mm and less than 10 mm, preferably at least 2 mm and at the maximum 5 mm.

7. Apparatus (100) comprising a multi-chamber container (100a) for the separate reception of at least two flowable components (A, B), which can be pressed in through outputs of the container into a tube part (10) which is placed onto the container, and comprising a mixer structure (1′) which is arranged in the tube part and which together with the tube part forms a static mixer (1) in accordance with any one of the claims 1 to 6.

8. Apparatus in accordance with claim 7, characterized in that the chambers (101, 102) of the container (100a) are cylindrical; and in that piston-like means (111, 112) are provided, by means of which the flowable components (A, B) can be pressed out of the chambers.

9. Use of a static mixer in accordance with any one of the claims 1 to 6, in particular in an apparatus (100) in accordance with claim 7 or claim 8, for mixing a highly viscous component (A) with at least one further component (B) which can have a viscosity which is less by a factor of from 10 to 1000, with it being possible for the mass flow of the further component to be less than the mass flow of the highly viscous component by a multiple.
